(19) United States
(12) Patent Application Publication
(10) Pub. No.: US 2024/0405386 A1
(43) Pub. Date: Dec. 5, 2024

(54) SECONDARY BATTERY

(71) Applicant: Samsung SDI Co., Ltd., Yongin-si (KR)

(72) Inventors: Kwang Soo BAE, Yongin-si (KR); Jun Sun YONG, Yongin-si (KR); Jun Hyung LEE, Yongin-si (KR); Jung Soo KIM, Yongin-si (KR)

(21) Appl. No.: 18/592,966

(22) Filed: Mar. 1, 2024

(30) Foreign Application Priority Data
Jun. 5, 2023 (KR) 10-2023-0072169

(51) Int. Cl. H01M 50/566; H01M 50/103; H01M 50/15; H01M 50/474; H01M 50/557

(52) U.S. Cl. CPC H01M 50/566; H01M 50/103; H01M 50/15; H01M 50/474; H01M 50/557

(57) ABSTRACT

A secondary battery including: an electrode assembly including a negative electrode tab and a positive electrode tab at opposite ends thereof in a longitudinal direction; a case accommodating the electrode assembly, both ends of the case in the longitudinal direction being open; a pair of cap plates respectively coupled to the open ends of the case; and a negative electrode terminal and a positive electrode terminal respectively electrically connected to the negative electrode tab and the positive electrode tab and exposed at an outside of the cap plates, respectively. A current collector is on an upper portion of the negative electrode tab or the positive electrode tab, a terminal connection part is on the current collector, and the terminal connection part passes through a plate hole in the cap plate to be electrically connected to the negative electrode terminal or the positive electrode terminal.

### CROSS-REFERENCE TO RELATED APPLICATIONS

This application claims priority to and the benefit of Korean Patent Application No. 10-2023-0072169, filed on Jun. 5, 2023, in the Korean Intellectual Property Office, the entire disclosure of which is incorporated by reference herein.

### BACKGROUND

### 1. Field

Embodiments of the present disclosure relate to a secondary battery.

### 2. Description of the Related Art

Secondary batteries are designed to be rechargeable unlike primary batteries. From among such secondary batteries, a low-capacity battery including a battery cell (e.g., a single battery cell) in the form of a pack may be used in small, portable electronic devices, such as cellular phones and camcorders, and a high-capacity battery module including tens or more battery packs connected to one another may be used as a power source, for example, for driving motors of hybrid vehicles, electric vehicles, and the like.

Generally, a secondary battery may include a case, an electrode assembly, a terminal, and a cap plate. The electrode assembly, in which a separator is interposed between a positive electrode plate and a negative electrode plate, and an electrolyte are accommodated in (or embedded in) the case, and the cap plate is welded to the case.

According to the related art, a separate rivet is used to electrically connect the terminal to a current collector. For example, after forming a hole (or an opening) in the cap plate, a hollow-type rivet is installed to pass through the hole. A gasket is disposed around the hole to insulate the rivet from surrounding components. The terminal disposed above the cap plate and the rivet are in physical contact with each other, the rivet and the current collector disposed below the cap plate are in physical contact with each other, and the rivet is welded to the current collector to conduct electricity between the current collector and the terminal.

According to the related art, a terminal connection part made of a bendable metal material may be used to electrically connect the current collector to a current collecting plate disposed below the current collector. A method for connecting the current collector to the current collecting plate by using the terminal connection part as a medium has been used.

Current collected through the current collecting plate is transmitted to the current collector via the terminal connection part, and the current collected through the current collector is transmitted to the terminal via the hollow-type rivet.

The current flow (or the flow of the current) in an assembly method according to a coupling structure according to the related art is: Current collecting plate→Terminal connection part→Current collector→Rivet→Terminal.

The coupling structure according to the related art, however, has a disadvantage in that the number of accessories required for electrical connection between components is large, and thus, the assembly structure is complicated.

The above-described information disclosed in the Background section acts as the background of the present disclosure is for improving understanding of the background of the present disclosure and, thus, may include information that does not constitute the related (or prior) art.

### SUMMARY

Embodiments of the present disclosure provide a secondary battery that includes a reduced number of components and implements a connection between a terminal and a current collector through a relatively simple structure.

According to an embodiment of the present disclosure, a secondary battery including: an electrode assembly including a negative electrode tab and a positive electrode tab at opposite ends thereof in a longitudinal direction; a case accommodating the electrode assembly, both ends of the case in the longitudinal direction being open; a pair of cap plates respectively coupled to the open ends of the case; and a negative electrode terminal and a positive electrode terminal respectively electrically connected to the negative electrode tab and the positive electrode tab and exposed at an outside of the cap plates, respectively. A current collector is on an upper portion of the negative electrode tab or the positive electrode tab, a terminal connection part is on the current collector, and the terminal connection part passes through a plate hole in the cap plate to be electrically connected to the negative electrode terminal or the positive electrode terminal.

The current collector may include: a first current collector welded to the negative electrode tab or the positive electrode tab of the electrode assembly; and a second current collector electrically connected to the first current collector. The terminal connection part may protrude upwardly from a top surface of the second current collector and may pass through the plate hole to be connected to a bottom surface of the negative electrode terminal or the positive electrode terminal.

The negative electrode terminal or the positive electrode terminal may include a terminal body and a flange protruding outwardly from an outer circumferential surface of a lower end of the terminal body, and the terminal body may have a cylindrical hole at a center thereof. A bottom surface of the cylindrical hole may be closed.

A bottom surface of the terminal body may have a flat shape and may be in contact with a top surface of the terminal connection part.

A recess having a shape corresponding to that of the terminal connection part may be defined in the bottom surface of the terminal body to accommodate a portion of the terminal connection part.

A shape of the terminal connection part may be any one of a cylindrical shape, a conical shape, a square pillar, or a hexagonal pillar, and the plate hole may be punched in a shape corresponding to the terminal connection part.

The terminal connection part may protrude downwardly from a bottom surface of the terminal and may pass through the plate hole to be connected to the top surface of the second current collector.

The terminal connection part may be integral with the second current collector.

The terminal connection part may be a separate component from the second current collector.

The second current collector may be directly welded to a top surface of the first current collector.

The second current collector may be made of the same material as the first current collector, and the second current collector may have a thickness greater than that of the first current collector.

The secondary battery may further include an insulator. The insulator may include a lower insulator below the cap plate, an upper insulator above the cap plate, and an intermediate insulator extending along an inner circumferential surface of the cap plate and connecting the lower insulator to the upper insulator. The negative electrode terminal or the position electrode terminal and the cap plate, and the cap plate and the second current collector may be insulated from each other through the insulator.

The negative electrode terminal or the positive electrode terminal and the insulator may be manufactured by using an insert molding manner.

The cap plates may have a low-level area that is lower than a surrounding area thereof in a top surface of the cap plate with a size corresponding to that of a plane of the upper insulator, and the upper insulator may be seated on the low-level area to be fixed in position in a direction of the plane.

### BRIEF DESCRIPTION OF THE DRAWINGS

The accompanying drawings are included to provide a further understanding of the present disclosure and are incorporated in and constitute a part of this specification. The drawings illustrate embodiments of the present disclosure and, together with the description, explain aspects and features of the present disclosure. In the drawings:

FIG. 1 is a perspective view of a secondary battery according to embodiments;

FIG. 2 is an exploded perspective view of the secondary battery shown in FIG. 1;

FIG. 3A is a perspective view of a terminal connection structure of the secondary battery according to an embodiment;

FIG. 3B is a cross-sectional view taken along the line A-A in FIG. 3A;

FIG. 4A is a perspective view of a terminal connection structure of a secondary battery according to another embodiment;

FIG. 4B is a cross-sectional view taken along the line A-A in FIG. 4A; and

FIGS. 5A to 5D shown various shapes of a terminal connection part.

### DETAILED DESCRIPTION

Hereinafter, embodiments will be described, in detail, with reference to the accompanying drawings. Embodiments of the present disclosure may, however, be embodied in many different forms and should not be construed as being limited to the embodiments set forth herein. Rather, these embodiments are provided so that this disclosure will be thorough and complete and will fully convey the scope of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

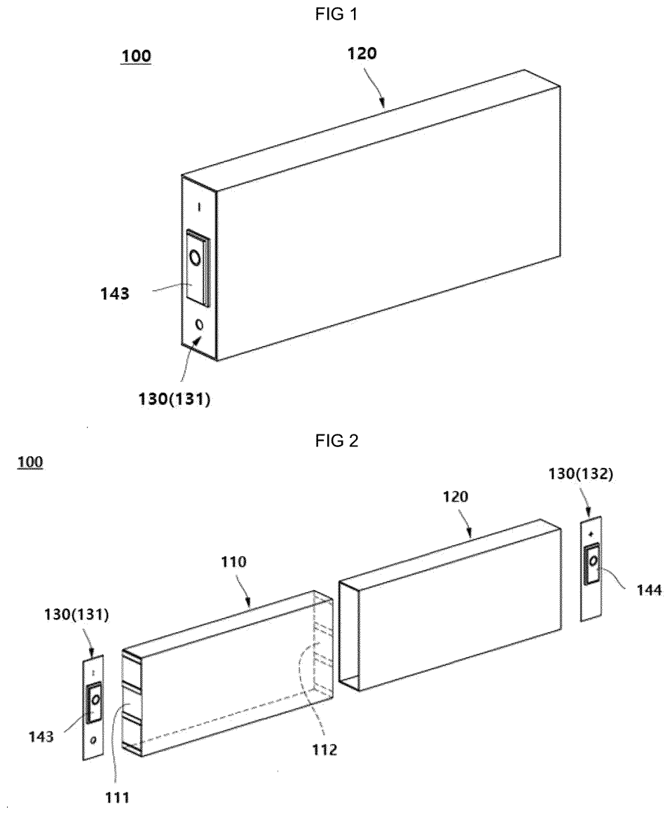

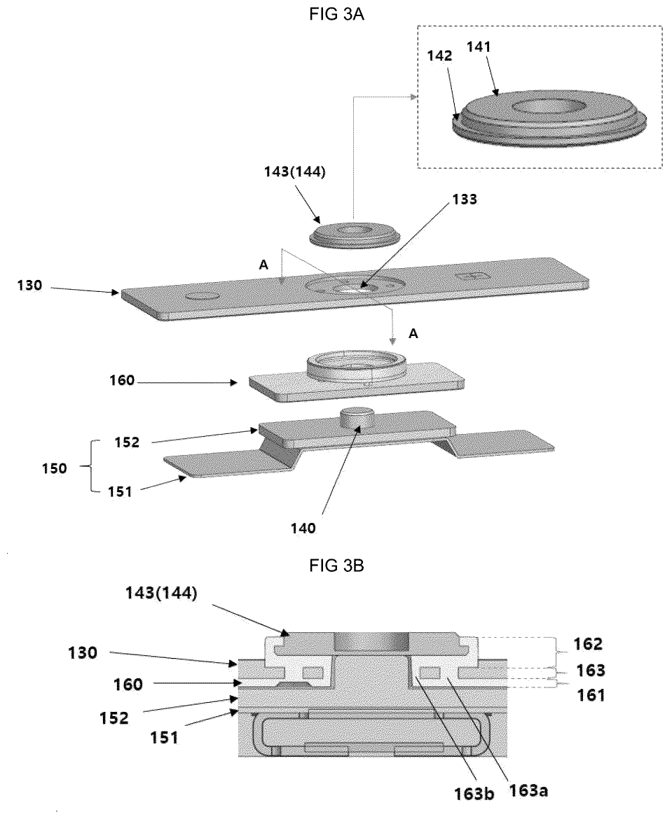

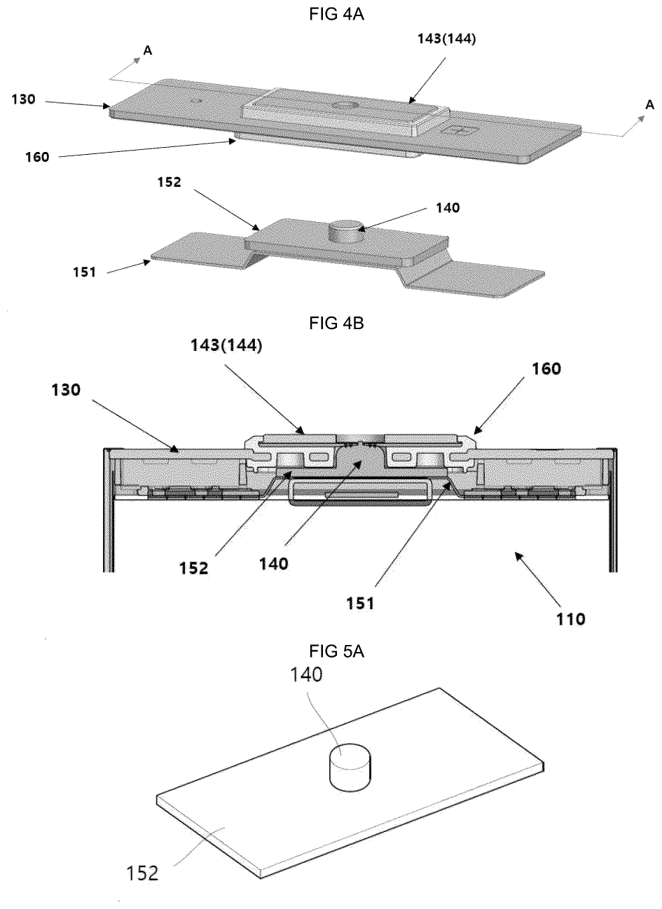

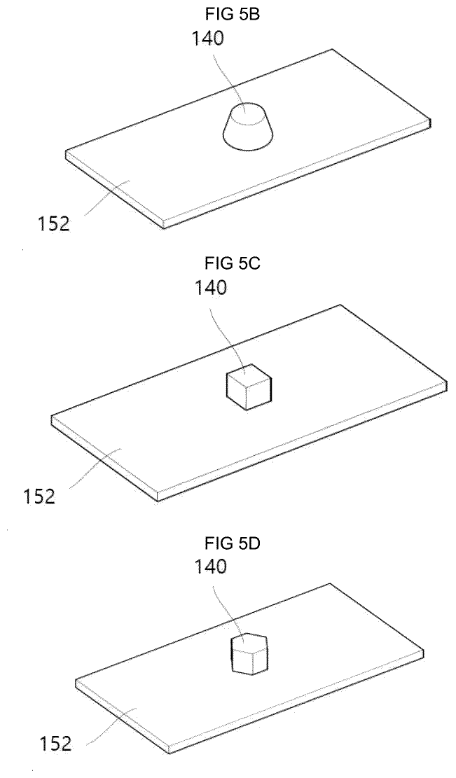

FIG. 1 is a perspective view of a secondary battery according to embodiments, FIG. 2 is an exploded perspective view of the secondary battery shown in FIG. 1, FIG. 3A is a perspective view of a terminal connection structure of the secondary battery according to an embodiment, FIG. 3B is a cross-sectional view taken along the line A-A in FIG. 3A, FIG. 4A is a perspective view of a terminal connection structure of a secondary battery according to another embodiment, FIG. 4B is a cross-sectional view taken along the line A-A in FIG. 4A, and FIGS. 5A to 5D show various shapes of a terminal connection part. Hereinafter, a secondary battery according to an embodiment of the present disclosure will be described.

A secondary battery 100, according to an embodiment of the present disclosure, may include an electrode assembly 110, a case 120, a pair of cap plates 130, a negative electrode terminal 143, and a positive electrode terminal 144.

The electrode assembly 110 may be manufactured by stacking or winding a negative electrode plate, a separator, and a positive electrode plate, each of which are provided in a thin plate shape or film shape. An outer appearance of the electrode assembly 110 manufactured in this manner may have a rectangular parallelepiped shape. In some embodiments, the electrode assembly 110 may have front and rear surfaces, each of which has a largest area from among the surfaces of the electrode assembly 110, top and bottom surfaces that are long sides, and left and right surfaces that are short sides. In some embodiments, after manufacturing the electrode assembly 110, a plurality of finishing tapes may be attached to the outside to maintain the shape of the electrode assembly 110.

The negative electrode plate may be manufactured by applying a negative electrode active material, such as graphite or carbon, to a negative electrode base material made of a metal foil, such as copper, a copper alloy, nickel, or a nickel alloy. A negative electrode non-coating portion on which the negative electrode active material is not applied may be a partial area of the negative electrode base material. A negative electrode tab 111 may be disposed or connected to the negative electrode non-coating portion. The negative electrode tab 111 may be disposed to face a left side, which is one end of the electrode assembly 110 in a longitudinal direction.

A positive electrode plate may be manufactured by applying a positive electrode active material, such as a transition metal oxide, to a positive electrode base material made of a metal foil, such as aluminum or an aluminum alloy. A positive electrode non-coating portion on which the positive electrode active material is not applied may be a partial area of the positive electrode base material. A positive electrode tab 112 may be disposed or connected to the positive electrode non-coating portion. The positive electrode tab 112 may be disposed to face a right side, which is the other end (e.g., the opposite end) of the electrode assembly in the longitudinal direction. That is, the negative electrode tab 111 and the positive electrode tab 112 may be disposed to face opposite directions.

The separator may be disposed between the negative electrode plate and the positive plate to prevent short circuits while enabling the movement of lithium ions therethrough. The separator may be made of polyethylene, polypropylene, or a composite film of polyethylene and polypropylene, but it is not limited thereto.

In some embodiments, the negative electrode tab 111 and the positive electrode tab 112 may be disposed on both ends (e.g., on opposite ends) of the electrode assembly 110 in the longitudinal direction, respectively. In some embodiments, the negative electrode tab 111 and the positive electrode tab 112 may be electrically connected to the negative electrode terminal 143 and the positive electrode terminal 144 with cap plates 131 and 132 therebetween, respectively. By using this arrangement, a size of each of the current collecting components may be reduced compared to a structure in which the negative electrode tab 111 and the positive electrode tab 112 are disposed at one side (e.g., at the same side). In some embodiments, space utilization inside the case 120 may be improved.

The case 120 may accommodate the electrode assembly 110, and both ends of the case 120 in the longitudinal direction may be open. The case 120 may be made of a conductive metal, such as aluminum, an aluminum alloy, or steel plated with nickel. For example, the case 120 may have a rectangular parallelepiped shape, and both the ends of the case 120 in the longitudinal direction may be open. When the electrode assembly 110 is accommodated in the case 120, the negative electrode tab 111 and the positive electrode tab 112, which are disposed at both the ends of the electrode assembly 110 in the longitudinal direction, may be disposed at both the ends of the case 120 in the longitudinal direction.

A pair of cap plates 131 and 132 may be coupled to both open ends of the case 120, respectively. Each of the cap plates 130 may be welded (e.g., laser welded) to an opening in the case 120 along a circumference. The first cap plate 131 may be coupled to one end of the case 120 in the longitudinal direction to seal the case 120, and the second cap plate 132 may be coupled to the other end of the case 120, which faces the first cap plate 131 in the longitudinal direction, to seal the case 120. In some embodiments, the cap plate 130 may include copper, nickel, aluminum, or stainless steel.

The negative electrode terminal 143 and the positive electrode terminal 144 may be provided outside the cap plate 130. The negative electrode terminal 143 may be exposed at a left side of the first cap plate 131, and the positive electrode terminal 144 may be exposed at a right side of the second cap plate 132.

The terminals 143 and 144 may be provided outside the cap plate 130, and these components may be electrically insulated from each other through an insulator 160. In some embodiments, the terminals 143 and 144 may be fixed in position through the insulator 160, and the terminals 143 and 144 and the terminal connection part 140 may be electrically connected to each other while maintaining an insulated state from the cap plate 130 via the insulator 160. In describing a structure of the insulator 160 with reference to FIG. 3B, the insulator 160 may be constituted by (or may include) a lower insulator 161 disposed below the cap plate 130, an upper insulator 162 disposed above the cap plate 130, and an intermediate insulator 163 extending along an inner circumferential surface of the plate hole 133 to connect (or to extend between) the lower insulator 161 to the upper insulator 162. The lower insulator 161 may have a hexahedral shape, as illustrated in FIG. 3A and, for example, may have a planar shape corresponding to a second current collector 152. A bottom surface of the lower insulator 161 may be in contact with the second current collector 152, and a top surface of the lower insulator 161 may be in contact with a bottom surface of the cap plate 130. A through-groove (or through-hole or opening), through which the above-described terminal connection part 140 passes, may be provided in the lower insulator 161. The upper insulator 162 may be disposed to be spaced upward from the lower insulator 161 by using the intermediate insulator 163 as a medium and may be seated on a top surface of the cap plate 130. The insulator 160 may be manufactured by using an insert molding method.

The negative electrode terminal 143 or the positive electrode terminal 144 and the cap plate 130 may be insulated through the insulator 160, arranged as described above. In some embodiments, because the cap plate 130 and the current collector 150 are disposed with the lower insulator 161 of the insulator 160 therebetween, the cap plate 130 and the second current collector 152 may be insulated from each other. In some embodiments, the terminal (e.g., the negative electrode terminal 143 or the positive electrode terminal 144) and the cap plate 130 and the cap plate 130 and the second current collector 152 may be electrically insulated from each other to prevent an electrical short from occurring.

For example, the negative electrode terminal 143 and the positive electrode terminal 144 may be provided outside the cap plate 130. In some embodiments, each of the terminals 143 and 144 may have a disk shape, as illustrated in FIG. 3A, or may have a flat hexahedral shape, as illustrated in FIG. 4A. Each of the terminals 143 and 144 may be constituted by (or may include) a terminal body 141 and a flange 142 protruding outwardly from a circumferential surface of a lower end of the terminal body 141. As illustrated in FIGS. 3A and 3B, the terminal body 141 may have a cylindrical hole (or opening) in a center thereof, and a bottom surface of the hole may be closed (e.g., the cylindrical hole may be a blind hole). In some embodiments, the terminal body 141 may have a flat bottom surface so that the terminal connection part 140 contacts the bottom surface of the terminal body 141. In some embodiments, the flange 142 may extend radially outwardly along an outer circumferential surface of the lower end of the terminal body 141. The flange 142 may be hung on (or set on) the upper insulator 162 and may then be fixed to the insulator 160 so that the terminals 143 and 144 are coupled to the insulator 160.

In some embodiments, as illustrated in FIG. 3A, a low-level area that is lower than (or below) a surrounding area thereof may be provided on the top surface of the cap plate 130 with a size corresponding to that of a plane of the upper insulator 162, and the upper insulator 162 may be seated on the low-level area and, thus, may be fixed in position in a direction of the plane. For example, the upper insulator 162 may have a cylindrical sidewall surrounding (or extending around) the terminals 143 and 144 to accommodate the disk-shaped terminals 143 and 144 therein, as illustrated in FIG. 3A. In some embodiments, an upper side of the upper insulator 162 may be open so that the terminals 143 and 144 are inserted downwardly, and a bottom surface of the upper insulator 162 may be provided with a through-groove (or through-hole or opening) through which the terminal connection part 140 passes. A hook part may be installed on an upper end of the cylindrical sidewall to extend along a circumference of the sidewall to prevent the terminals 143 and 144 from being separated. The intermediate insulator 163 may include at least one post part 163a connecting the upper insulator 162 to the lower insulator 161 and an inner circumferential wall part 163b extending along the inner circumferential surface of the plate hole 133 to connect the lower insulator 161 to the upper insulator 162.

The terminals 143 and 144 may be inserted into and fixed to the upper insulator 162, and then, the flange 142 of each of the terminals 143 and 144 may be fixed in position to the sidewall hook part of the upper insulator 162. Because the insulator 160 is mounted on the cap plate 130 in the state of accommodating the terminals 143 and 144, the terminals 143 and 144 may be fixed to the cap plate 130 by using the insulator 160 as a medium. When each of the terminals 143 and 144 has a circular donut shape, as illustrated in FIG. 3A, the upper insulator 162 may have a cylindrical sidewall to accommodate the disk-shaped terminals 143 and 144 therein. In some embodiments, when each of the terminals 143 and 144 has a flat hexahedral shape, as illustrated in FIG. 4A, the upper insulator 162 may have a square sidewall to accommodate the square-shaped terminals 143 and 144 therein. In some embodiments, the terminal body 141 of the terminals 143 and 144 may protrude more upwardly than (e.g., may protrude above) the upper insulator 162 to act as a busbar. The negative electrode terminal 143 and the positive electrode terminal 144 may be manufactured by using an insert molding method.

The negative electrode terminal 143 and the positive electrode terminal 144, which are coupled to the insulator 160, may be electrically connected to the current collector 150 below the cap plate 130 through the terminal connection part 140 disposed to pass through the cap plate 130, respectively. As a result, the negative electrode terminal 143 and the positive electrode terminal 144 may be electrically connected to the negative electrode tab 111 and the positive electrode tab 112 of the electrode assembly 110, respectively. In some embodiments, the current collector 150 may be provided on an upper portion of the negative electrode tab 111 or the positive electrode tab 112 of the electrode assembly 110, and the current collector 150 may be provided with the terminal connection part 140. The plate hole (or opening) 133 may be defined in the cap plate 130 to spatially communicate with upper and lower sides of the cap plate 130. The terminal connection part 140 may be disposed to pass through the plate hole 133. The current collector (e.g., the second current collector 152) disposed below the cap plate 130 and the positive electrode terminal 144 or the negative electrode terminal 143 disposed above the cap plate 130 may be electrically connected to each other through the terminal connection part 140. Hereinafter, the current collector 150 and the terminal connection part 140 will be described in detail.

Each current collector 150 may include a first current collector 151 welded to the negative electrode tab 111 or the positive electrode tab 112 of the electrode assembly 110 and the second current collector 152 electrically connected to the first current collector 151.

The first current collector 151 may be welded to the negative electrode tab 111/positive electrode tab 112 (e.g., the negative electrode non-coating portion tab/the positive electrode non-coating portion tab) of the electrode assembly 110. The negative electrode non-coated tab may be provided by cutting the negative electrode plate so that the negative electrode plate protrudes in a lateral direction when the negative electrode plate is manufactured, and approximately two negative electrode non-coating portions may be provided to protrude in the lateral direction of the electrode assembly 110.

The first current collector 151 may be divided into a central first area and second and third areas at both sides of the first area. In some embodiments, the first current collector 151 may have a shape in which the first to third areas are disposed on the same plane (e.g., a structure without a stepped portion). In some embodiments, as illustrated in the drawings, the first current collector 151 may have a structure in which a stepped portion is provided between the first area and the second and third areas. The first area may be an area that is electrically coupled to the second current collector 152 and may be spaced apart from the electrode assembly 110 and the non-coating portion tabs. The second areas may be bent to extend outwardly and downwardly from the first area to the non-coating portion tabs disposed at both sides thereof. The third areas may extend from the second areas and may be welded to the non-coating portion tabs, respectively. The stepped portion may be applied in the form described above to the first current collector 151 to provide elasticity. The first current collector 151 may have the stepped structure to provide its own elasticity, and thus, adhesion with the second current collector 152 disposed thereon may be increased to improve welding quality with the second current collector 152. In some embodiments, the first current collector 151 may include copper, nickel, aluminum, or stainless steel.

The second current collector 152 may be electrically connected to the first current collector 151. In some embodiments, as illustrated in FIG. 3A, the second current collector 152 may be provided on the first area of the first current collector 151. The second current collector 152 may be integrated (or integral) with the first current collector 151 or may be provided separately and then welded to the first current collector 151. According to embodiments of the present disclosure, the second current collector 152 may be directly coupled to the top surface of the first current collector 151 by welding. In some embodiments, the second current collector 152 may be previously coupled to the top surface of the first current collector 151 in a laser welding manner.

As described above, in the terminal coupling structure according to the related art, the bendable terminal connection part may be used for electrical connection between the first current collector 151 and the second current collector 152. In some embodiments, a first edge of the terminal connection part may be laser welded to the first current collector 151, and the second current collector 152 may be laser welded to a second edge disposed at a side opposite to the first edge of the terminal connection part. In some embodiments, current collected through the first current collector 151 may be transmitted to the second current collector 152 via the terminal connection part. According to some embodiments of the present disclosure, the second current collector 152 and the first current collector 151 may be directly coupled (e.g., terminal connection part is removed or omitted) to each other without using an intermediate medium for transmitting the current.

In some embodiments, the second current collector 152 may be made of the same material as the first current collector 151. In some embodiments, the second current collector 152 may include copper, nickel, aluminum, or stainless steel.

In some embodiments, the second current collector 152 may have a thickness greater than that of the first current collector 151 and a width greater than that of the first current collector 151. The current collection effect may be improved by designing the longitudinal cross-section of the second current collector 152 to be larger than that of the first current collector 151.

The terminal connection part 140 may be disposed to pass through the plate hole 133 provided in the cap plate 130 to electrically connect the negative electrode terminal 143 or the positive electrode terminal 144, which is disposed at the upper side, to the current collector 150. In some embodiments, the terminal connection part 140 may be made of a material configured to (or capable of) conducting electricity and may be made of the same material as the second current collector 152 and the terminal, that is, copper, nickel, aluminum, or stainless steel.

In some embodiments, the terminal connection part 140 may be disposed on the second current collector 152. In some embodiments, the terminal connection part 140 may protrude upwardly from the top surface of the second current collector 152, may pass through the plate hole 133, and may be connected to the bottom surface of the negative electrode terminal 143 or the positive electrode terminal 144. The terminal connection part 140 may be integrated (or integral) with the second current collector 152, or the terminal connection part 140 may be provided as a separate component from the second current collector 152.

The bottom surface of the terminals 143 and 144 (e.g., the bottom surface of the terminal body 141) may have a flat shape and may then be in surface contact with the top surface of the terminal connection part 140 (see, e.g., FIG. 3B). In some embodiments, a recess may be defined in the bottom surface of the terminal (e.g., the bottom surface of the terminal body 141) in a shape corresponding to the shape of the terminal connection part 140 to accommodate a portion of the terminal connection part 140.

In other embodiments, the terminal connection part 140 may be disposed on the terminals 143 and 144. For example, the terminal connection part 140 may protrude downwardly from the bottom surface of the terminals 143 and 144, may pass through the plate hole 133, and may be connected to the top surface of the second current collector 152. In some embodiments, the top surface of the second current collector 152 may be provided to have a flat shape and may then be in surface contact with the bottom surface of the terminal connection part 140. In some embodiments, a recess may be defined in the top surface of the second current collector 152 in a shape corresponding to the shape of the terminal connection part 140 to accommodate a portion of the terminal connection part 140.

In some embodiments, in which the terminal connection part 140 is disposed on the second current collector 152, the terminal connection part 140 and the terminals 143 and 144 may be electrically connected to each other by the welding. In some embodiments, in which the terminal connection part 140 is disposed on the terminals 143 and 144, the terminal connection part 140 and the second current collector 152 may be electrically connected to each other by welding. For example, a method for performing welding in a state in which a clad sheet (e.g., two layers that are thermally compressed) made of aluminum (about 2 T) and copper (about 0.5 T to about 0.7 T) is disposed between the terminals 143 and 144 and the second current collector 152 may be used.

In some embodiments, a three-dimensional shape of the terminal connection part 140 is not limited to the cylindrical shape in FIG. 3A and 4A and may be provided in any one of the following shapes, for example, the conical shape shown in FIG. 5B, the square pillar shown in FIG. 5C, and the hexagonal pillar shown in FIG. 5D. In some embodiments, the plate hole 133 through which the terminal connection part 140 passes may be punched in a shape corresponding to the terminal connection part 140.

Flow of current in an assembly method according to a coupling structure according to the related art is: Current collecting plate→Terminal connection part→Current collector→Rivet→Terminal.

Flow of current in an assembly method according to coupling structure according to embodiments of the present disclosure is: First current collector 151→Second current collector 152→Terminals 143 and 144.

As compared above, according to the coupling structure of embodiments of the present disclosure, because the first current collector 151 and the second current collector 152 are directly coupled to each other by a method, such as the laser welding, the first current collector 151 and the second current collector 152 may be connected to each other without components, such as the terminal connection part, to reduce the number of components and simplify the structure.

In some embodiments, the terminal connection part 140 may be provided on the second current collector 152, and a recess that accommodates the terminal connection part 140 may be provided. In other embodiments, the terminal connection part 140 may be provided on the terminal, and the structure (e.g., the recess/flat shape) that accommodates the terminal connection part 140 may be provided to electrically connect the second current collector 152 to the terminal without a hollow rivet, according to the related art, thereby reducing the number of components and simplifying the structure.

According to some embodiments, the number of components is reduced, and the electrical connection between the terminal and the current collector is realized through a relatively simple structure.

The above-mentioned embodiments are merely some embodiments of the secondary battery, and thus, the present disclosure is not limited to the foregoing embodiments. Also, it will be understood by those of ordinary skill in the art that various changes in form and details may be made therein without departing from the spirit and scope of the present disclosure as defined by the following claims and their equivalents.

What is claimed is:

1. A secondary battery comprising:
an electrode assembly comprising a negative electrode tab and a positive electrode tab at opposite ends thereof in a longitudinal direction;
a case accommodating the electrode assembly, both ends of the case in the longitudinal direction being open;
a pair of cap plates respectively coupled to the open ends of the case; and
a negative electrode terminal and a positive electrode terminal respectively electrically connected to the negative electrode tab and the positive electrode tab and exposed at an outside of the cap plates, respectively,
wherein a current collector is on an upper portion of the negative electrode tab or the positive electrode tab,
wherein a terminal connection part is on the current collector, and
wherein the terminal connection part passes through a plate hole in the cap plate to be electrically connected to the negative electrode terminal or the positive electrode terminal.

2. The secondary battery as claimed in claim 1, wherein the current collector comprises:
a first current collector welded to the negative electrode tab or the positive electrode tab of the electrode assembly; and
a second current collector electrically connected to the first current collector,
wherein the terminal connection part protrudes upwardly from a top surface of the second current collector and passes through the plate hole to be connected to a bottom surface of the negative electrode terminal or the positive electrode terminal.

3. The secondary battery as claimed in claim 1, wherein the negative electrode terminal or the positive electrode terminal comprises a terminal body and a flange protruding outwardly from an outer circumferential surface of a lower end of the terminal body, and
wherein the terminal body has a cylindrical hole at a center thereof, a bottom surface of the cylindrical hole being closed.

4. The secondary battery as claimed in claim 3, wherein a bottom surface of the terminal body has a flat shape and is in contact with a top surface of the terminal connection part.

5. The secondary battery as claimed in claim 3, wherein a recess having a shape corresponding to that of the terminal connection part is defined in the bottom surface of the terminal body to accommodate a portion of the terminal connection part.

6. The secondary battery as claimed in claim 1, wherein a shape of the terminal connection part is any one of a cylindrical shape, a conical shape, a square pillar, or a hexagonal pillar, and
wherein the plate hole is punched in a shape corresponding to the terminal connection part.

7. The secondary battery as claimed in claim 2, wherein the terminal connection part protrudes downwardly from a bottom surface of the terminal and passes through the plate hole to be connected to the top surface of the second current collector.

8. The secondary battery as claimed in claim 2, wherein the terminal connection part is integral with the second current collector.

9. The secondary battery as claimed in claim 2, wherein the terminal connection part is a separate component from the second current collector.

10. The secondary battery as claimed in claim 2, wherein the second current collector is directly welded to a top surface of the first current collector.

11. The secondary battery as claimed in claim 2, wherein the second current collector is made of the same material as the first current collector, and wherein the second current collector has a thickness greater than that of the first current collector.

12. The secondary battery as claimed in claim 2, further comprising an insulator,
wherein the insulator comprises a lower insulator below the cap plate, an upper insulator above the cap plate, and an intermediate insulator extending along an inner circumferential surface of the cap plate and connecting the lower insulator to the upper insulator, and
wherein the negative electrode terminal or the position electrode terminal and the cap plate, and the cap plate and the second current collector are insulated from each other through the insulator.

13. The secondary battery as claimed in claim 12, wherein the negative electrode terminal or the positive electrode terminal and the insulator are manufactured by using an insert molding manner.

14. The secondary battery as claimed in claim 12, wherein the cap plates have a low-level area that is lower than a surrounding area thereof in a top surface of the cap plate with a size corresponding to that of a plane of the upper insulator, and
wherein the upper insulator is seated on the low-level area to be fixed in position in a direction of the plane.
